(19) United States
(12) Patent Application Publication
(10) Pub. No.: US 2010/0172343 A1
(43) Pub. Date: Jul. 8, 2010

(54) Dynamic Network Classification

(75) Inventors: Regis J. Crinon, Camas, WA (US); William Lewis Looney, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/348,018

(22) Filed: Jan. 2, 2009

(51) Int. Cl. H04L 12/66

(52) U.S. Cl. 370/352

(57) ABSTRACT

A round trip time (“RTT”) is measured between a Voice over Internet Protocol (“VoIP”) endpoint and a mediation server across a network. A determination is made whether the measured RTT is consistent with one of a plurality of network classification values. Each of the plurality of network classification values may correspond to a network policy. In response to determining that the measured RTT is consistent with one of the plurality of network classification values, the corresponding network policy is applied to configure bandwidth management on the VoIP endpoint.

### BACKGROUND

Telephony encompasses the general use of equipment to provide voice communication over a distance. Plain old telephone service (“POTS”) is a basic form of residential and small business telephone service. POTS became available in the United States soon after the telephone system was introduced in the late 19th century and, from the standpoint of the user, has existed more or less unchanged ever since. POTS services include a bi-directional or full duplex voice path with a limited frequency range, a dial tone and ringing signal, subscriber dialing, operator services such as directory assistance, and long distance and conference calling. During the 1970s and 1980s, new network services became available due to the creation of electronic telephone exchanges and computerization. These new services included voice mail, caller identification (“ID”), call waiting, reminder calls and other similar services.

Advances in digital electronics have revolutionized telephony by providing alternate means of voice communication to those provided by traditional (i.e., analog) telephone systems. Internet Protocol (“IP”) telephony is a form of telephony that uses the TCP/IP protocol popularized by the Internet to transmit digitized voice data. The routing of voice conversations over the Internet or through other IP networks is also called Voice over IP (“VoIP”). Digital telephony was introduced to improve voice services, but was subsequently found to be very useful in the creation of new network services because it can transfer data quickly over telephone lines. Session Initiation Protocol (“SIP”) is a signaling protocol used for creating, modifying and terminating call sessions (i.e., voice calls and/or video calls) with one or more participants.

In VoIP solutions, there are several broad classifications of IP networks over which a given call session can be established. Examples of network classifications include local area networks (“LANs”), wide area networks, (“WANs”), and metro area networks (“MANs”). Each network classification may vary in terms of available bandwidth, billing models, network quality, and administrative rules, as typically determined by a broadband service provider.

A VoIP endpoint may have different policies depending on the type of network over which a call session is being routed. As such, the VoIP endpoint may request the classification of the network being traversed. However, it is often difficult for the VoIP endpoint to determine the network classification for a given call session because the network classification is usually isolated from the network nodes (e.g., routers, switches) that have knowledge of the network classification.

It is with respect to these considerations and others that the disclosure made herein is presented.

### SUMMARY

Technologies are described herein for dynamically determining network classification. In particular, a round trip time (“RTT”) is measured between a VoIP endpoint and a mediation server across a network. The measured RTT may be analyzed to identify the classification of the network. For example, the measured RTT may be compared against typical RTT values for known network classifications. Upon determining the classification of the network utilizing the RTT, the VoIP endpoint can apply a network policy corresponding to the classification. The network policy may include a coder-decoder (“codec”) selection and other bandwidth management options.

According to one embodiment presented herein for dynamically determining network classification, a RTT is measured between a VoIP endpoint and a server across a network. A determination is made as to whether the measured RTT is consistent with one of a plurality of network classification values. Each of the plurality of network classification values may correspond to a network policy. In response to determining that the measured RTT is consistent with one of the plurality of network classification values, the corresponding network policy is applied to configure bandwidth management on the VoIP endpoint. The network policy may include the format with which real-time media is delivered.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram showing a network architecture capable of dynamically determining a network classification;

FIG. 2 is a flow diagram showing an illustrative process for dynamically determining a network classification; and

FIG. 3 is a computer architecture diagram showing an illustrative computer hardware architecture for a computing system capable of implementing the embodiments presented herein.

### DETAILED DESCRIPTION

The following detailed description is directed to technologies for dynamically determining a network classification. Through the utilization of the technologies and concepts presented herein, a VoIP endpoint may determine a type of network across which a given call session is routed. In particular, an observable distinction between network classifications, such as WAN, LAN, and MAN networks, may be determined based upon the amount of time needed for packets to propagate back and forth between a VoIP endpoint and a server in the VoIP infrastructure. This amount of time is commonly referred to as round-trip time (“RTT”). An example of a server in the VoIP infrastructure is a Mediation Server, which is used for converting VoIP calls into conventional PSTN calls passing through a PSTN gateway.

By measuring the RTT during a call session and analyzing the measured RTT against typical RTT values for different network classifications, a VoIP endpoint can dynamically determine the type of network being utilized by the given call session. The VoIP endpoint may then apply appropriate policies, such as codec selection for processing voice data and other bandwidth management operations, according to the type of network being utilized by the given call session.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

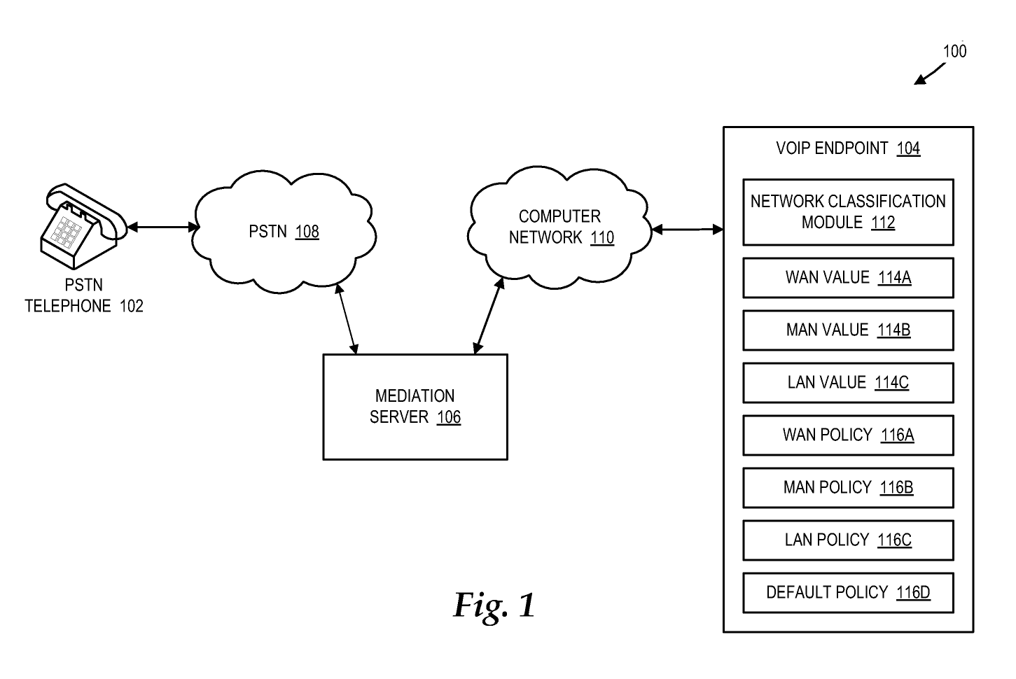

In the following detailed description, references are made to the accompanying drawings that form a part hereof, and which are shown by way of illustration specific embodiments or examples. Referring now to the drawings, in which like numerals represent like elements through the several figures, concepts and technologies for dynamically determining a network classification will be described. In particular, FIG. 1 illustrates a simplified network architecture 100 operative to provide a call session between a public switched telephone network (“PSTN”) infrastructure and a VoIP infrastructure. The network architecture 100 includes a PSTN telephone 102 and a VoIP endpoint 104 operatively coupled via a mediation server 106. The PSTN telephone 102 is any suitable device operative to make and receive telephone calls over a PSTN network 108. The VoIP endpoint 104 is any suitable device operative to make and receive voice communications over a computer network 110.

Although not so limited, embodiments described herein primarily refer to voice call sessions implemented on the network architecture 100. However, it should be appreciated that the VoIP endpoint 104 may be further operative to transmit and receive video, application sharing data, and/or audio. Further, although not so limited, embodiments described herein primarily refer to call sessions between the PSTN telephone 102 and the VoIP endpoint 104. However, it should be appreciated that the embodiments may be similarly implemented for call sessions between two or more VoIP endpoints.

Examples of the VoIP endpoint 104 include a computer, a VoIP telephone, or an analog telephone connected to an analog telephone adaptor (“ATA”). Examples of the computer network 110 may include the Internet, an intranet, a WAN, a MAN, and a LAN. In one embodiment the computer network 110 is an enterprise network. Although only one VoIP endpoint is illustrated in FIG. 1, it should be appreciated that the network architecture 100 may include any number of VoIP endpoints operatively coupled to the mediation server 106 through the computer network 110.

The mediation server 106 is operative to enable communication between the PSTN network 108 and the computer network 110, and in particular, between the PSTN telephone 102 and the VoIP endpoint 104. For example, the mediation server 106 may initiate and terminate call sessions with the VoIP endpoint 104 via SIP messages. Further, the mediation server 106 may convert audio into an appropriate format suitable for transmission across the PSTN network 108 or the computer network 110.

The various types of computer networks, such as WAN, MAN, and LAN are referred to herein as network classifications. The available bandwidth on the computer network 110 may significantly differ depending on the network classification. For example, a LAN may provide a more liberal allocation of bandwidth than a WAN. In light of features and limitations associated with the network classification, the VoIP endpoint 104 may implement specific policies directed to the particular network classification.

In one embodiment, the policies may implement a particular codec corresponding to the network classification. The term “codec” is a combination of the words “coding” and “decoding” and is used with digital audio data and other media. A codec is a software program that converts an analog voice signal into a digital version of the voice signal and vice versa. Codecs can vary in their sound quality, the bandwidth that is required to use them, and the system requirements that are needed to perform the encoding/decoding. Examples of audio codecs may include G.711, G723.1, and RTAUDIO from MICROSOFT CORPORATION. Although not so limited, the embodiments described herein primarily refer to audio codecs. However, it should be appreciated that voice codecs, video codecs, and other suitable media codecs may be similarly utilized.

Each codec may provide a different tradeoff between audio quality and bandwidth utilization. For example, G.711 provides a very high standard of audio quality, but utilizes a significant amount of bandwidth in order to transfer data to achieve that level of audio quality. RTAUDIO provides a lower standard of audio quality than G.711, but utilizes less bandwidth for transferring audio data. As such, G.711 may be appropriate if the computer network 110 is classified as a LAN, which typically has less constraints on allocation of bandwidth. Further, RTAUDIO may be appropriate if the computer network 110 is classified as a WAN in order to conserve bandwidth.

As shown in FIG. 1, the VoIP endpoint 104 includes a network classification module 112. According to embodiments, the network classification module 112 is operative to measure the RTT during a call session and to analyze the measured RTT against previously defined RTT values corresponding to different network classifications. For example, the pre-defined RTT values may include a WAN value 114A associated with a WAN, a MAN value 114B associated with a MAN, and a LAN value 114C associated with a LAN. It should be appreciated that other values associated with other types of networks may be similarly implemented.

In one embodiment, the RTT is defined as the time that it takes for a packet to be sent from the VoIP endpoint 104 to the mediation server 106 and for an acknowledgement to be returned from the mediation server 106 back to the VoIP endpoint 104. The RTT may be variable depending on the classification of the computer network 110 across which the packet is transmitted. For example, the RTT for a LAN may be significantly lower than the RTT for a WAN. In another embodiment, RTT is also introduced and described in the Request for Comments (“RFC”) 3550 from the Internet Engineering Task Force (“IETF”).

A variety of approaches for measuring the RTT may be known to those skilled in the art. At least one approach is defined in RFC 3550, which provides the specification for the RTP and RTCP standards. The approach works for either the Transmission Control Protocol (“TCP”) or User Datagram Protocol (“UDP”) transport protocol and is based on the Last Sender Report (“LSR”) and the Delay since Last Sender Report (“DLSR”) fields in the receiver reports and the time at which the sender receives the receiver report. Alternatively, in an illustrative and simplified implementation for the TCP transport protocol, the VoIP endpoint 104 sends a packet at an initial clock reading to the mediation server 106. Upon receiving the packet, the mediation server 106 immediately returns an acknowledgement back to the VoIP endpoint 104. The VoIP endpoint 104 then calculates the RTT by subtracting the initial clock reading from the current clock reading when the acknowledgement is received at the end of the round trip.

In one embodiment, the RTT is measured multiple times until a statistical trend has been achieved. In particular, the statistical trend may convey a confidence that the measured RTT is sufficient for classifying the computer network 110. In one approach, a statistical trend may be achieved if the standard deviation of the RTT measurements is less than a given threshold. Other approaches may utilize any suitable statistical data (e.g., mean, median, min, max, etc.) in order to determine whether a statistical trend has been achieved.

The network classification module 112 may compare the measured RTT against the stored WAN value 114A, the MAN value 114B, and the LAN value 114C (collectively referred to as network classification values 114). If the measured RTT is consistent with the WAN value 114A, then the network classification module 112 may identify the computer network 110 as a WAN. If the measured RTT is consistent with the MAN value 114B, then the network classification module 112 may identify the computer network 110 as a MAN. If the measured RTT is consistent with the LAN value 114C, then the network classification module 112 may identify the network as a LAN. The measured RTT may be considered “consistent” with the network classification values 114 if the measured RTT is equal to those values or is within a given threshold of those values.

In one embodiment, the network classification values 114 are determined by observing the typical RTT values of networks where the classification is known. The network classification values 114 may be set values or adjustable values. Further, the network classification values 114 may be a specific number or a range of numbers. Different administrators at different VoIP endpoints may implement different network classification values 114.

In response to identifying the computer network 110 as a WAN, the network classification module 112 may apply a WAN policy 116A. In response to identifying the computer network 110 as a MAN, the network classification module 112 may apply a MAN policy 116B. In response to identifying the computer network 110 as a LAN, the network classification module 112 may apply a LAN policy 116C. If the computer network 110 is not identified as a WAN, MAN, or LAN (i.e., the measured RTT is not consistent with the network classification values 114), then the network classification module 112 may apply a default policy 116D.

The WAN policy 116A, the MAN policy 116B, the LAN policy 116C, and the default policy 116D (collectively referred to as network policies 116) may include any suitable bandwidth management options directed at the identified classification of the computer network 110. In one embodiment, the network policies 116 include a different selection of codecs corresponding to whether the computer network 110 is classified as a WAN, MAN, LAN, or other suitable type of network. For example, one illustrative network policy may select a lower bitrate codec when the computer network 110 is identified as a WAN and a higher bitrate codec when the computer network 110 is identified as a LAN. It should be appreciated that a different selection of codecs may refer to the same codec at different bitrates. Thus, different network policies may actually implement the same codec but at different bitrates.

By implementing the network classification module 112 within the VoIP endpoint 104, the VoIP endpoint 104 can dynamically adjust its network policy from call to call. The VoIP endpoint 104 can also handle changes to the call routing topology without manual VoIP administrator intervention. The embodiments described herein also eliminate the need for separate devices dedicated to applying the appropriate network policies 116. For example, an alternative solution may route call sessions from the VoIP endpoint 104 to a central server (not shown) that applies appropriate network policies. This alternative solution is generally undesirable because it may require the central server to provision a large set of IP subnets and to maintain classification rules for the IP subnets.

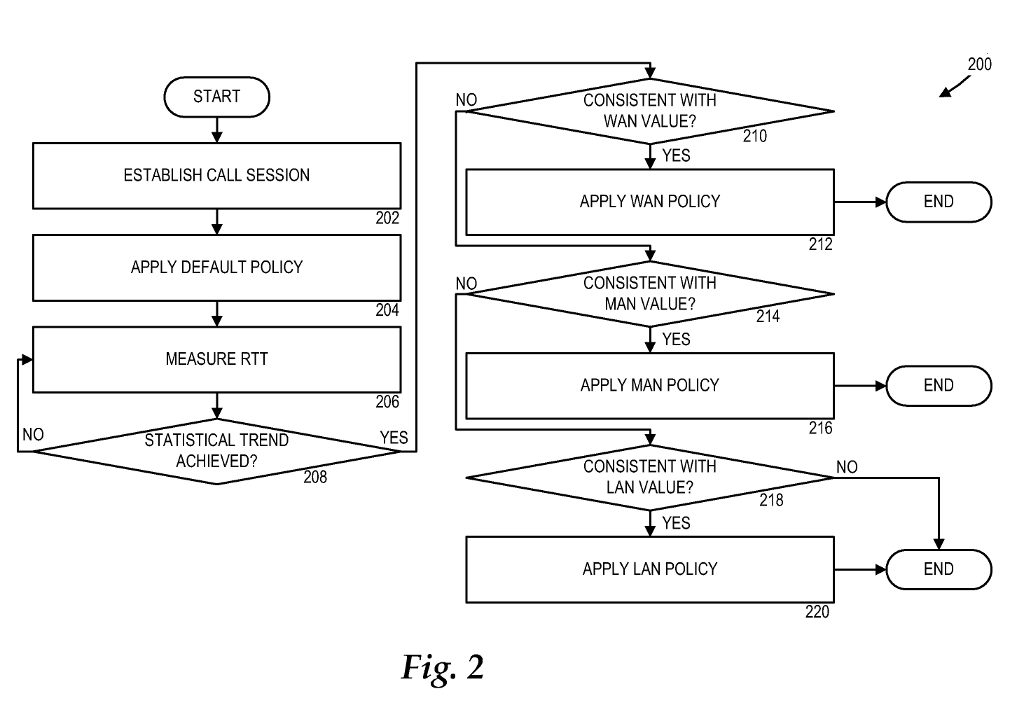

Referring now to FIG. 2, additional details will be provided regarding the embodiments presented herein for dynamically determining a network classification. In particular, FIG. 2 is a flow diagram illustrating one method for dynamically determining a network classification at a VoIP endpoint, such as the VoIP endpoints 104. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

A routine 200 begins at operation 202, where a call session is established on the computer network 110 between, for example, the PSTN telephone 102 and the VoIP endpoint 104. The routine 200 then proceeds to operation 204, where the network classification module 112 applies the default policy 116D at the beginning of the call session. The default policy 116D may include default bandwidth management options suitable for most types of networks. For example, the default policy 116D may include a codec selection that conservatively utilizes bandwidth. The default policy 116D may represent a default state regarding bandwidth management options. Upon applying the default policy 116D, the routine 200 proceeds to operation 206.

At operation 206, the network classification module 112 measures the RTT between the VoIP endpoint 104 and the mediation server 106. As previously described, the RTT is defined as the time that it takes for a packet to be sent from the VoIP endpoint 104 to the mediation server 106 and for an acknowledgement to be returned from the mediation server 106 back to the VoIP endpoint 104. One approach for measuring RTT is described in RFC 3550 from the IETF. Other approaches for measuring RTT as contemplated by those skilled in the art may be similarly utilized.

The routine 200 then proceeds to operation 208, where the network classification module 112 determines whether the RTT has been measured a number of times such that a statistical trend has been achieved. In particular, the statistical trend may be utilized to establish a confidence in the consistency of the RTT measurements. In one embodiment, the statistical trend may be achieved if a standard deviation over multiple RTT measurements is lower than a given threshold by a pre-determined instant into the call. In other embodiments, the statistical trend may be determined based on other statistical properties, such as mean, median, min, and max.

If the network classification module 112 determines that the statistical trend has been achieved, then the network classification module 112 proceeds to operation 206, where the network classification module 112 continues to measure the RTT between the VoIP endpoint 104 and the mediation server 106. If the network classification module 112 determines that the statistical trend has been achieved, then the routine 200 proceeds to operations 210-220 as described in greater detail below.

At operations 210-220, the network classification module 112 compares the measured RTT with the network classification values 114. In particular, the network classification module 112 may determine whether the measured RTT is consistent with the network classification values 114. As previously described, the measured RTT may be considered “consistent” with the network classification values 114 if the measured RTT is equal to those values or is within a given threshold of those values.

As illustrated in the example of FIG. 2, at operation 210, the network classification module 112 determines whether the measured RTT is consistent with the WAN value 114A. If the network classification module 112 determines that the measured RTT is consistent with the WAN value 114A, then the routine 200 proceeds to operation 212 where the network classification module 112 applies the WAN policy 116A to configure bandwidth management on the VoIP endpoint 104 from the default state represented by the default policy 116D into a non-default state represented by the WAN policy 116A. The WAN policy 116A may include appropriate bandwidth management options, such as a particular codec selection, corresponding to the identification of the computer network 110 as a WAN.

Upon the network classification module 112 applying the WAN policy 116A, the routine 200 terminates, and the call session continues according to the WAN policy 116A. Alternatively, the routine 200 may return to operation 206, where the network classification module 112 continues to measure the RTT between the VoIP endpoint 104 and the mediation server 106. If the network classification module 112 determines that the measured RTT is not consistent with the WAN value 114A, then the routine 200 proceeds to operation 214.

At operation 214, the network classification module 112 determines whether the measured RTT is consistent with the MAN value 114B. If the network classification module 112 determines that the measured RTT is consistent with the MAN value 114B, then the routine proceeds to operation 216 where the network classification module 112 applies the MAN policy 116B to configure bandwidth management on the VoIP endpoint 104 from the default state represented by the default policy 116D into a non-default state represented by the MAN policy 116B. The MAN policy 116B may include appropriate bandwidth management options, such as a particular codec selection, corresponding to the identification of the computer network 110 as a MAN.

Upon the network classification module 112 applying the MAN policy 116B, the routine 200 terminates, and the call session continues according to the MAN policy 116B. Alternatively, the routine 200 may return to operation 206, where the network classification module 112 continues to measure the RTT between the VoIP endpoint 104 and the mediation server 106. If the network classification module determines that the measured RTT is not consistent with the MAN value 114B, then the routine 200 proceeds to operation 218.

At operation 218, the network classification module 112 determines whether the measured RTT is consistent with the LAN value 114C. If the network classification module 112 determines that the measured RTT is consistent with the LAN value 114C, then the routine 200 proceeds to operation 220 where the network classification module 112 applies the LAN policy 116C to configure bandwidth management on the VoIP endpoint 104 from the default state represented by the default policy 116D into a non-default state represented by the LAN policy 116C. The LAN policy 116C may include appropriate bandwidth management options, such as a particular codec selection, corresponding to the identification of the computer network 110 as a LAN.

Upon the network classification module 112 applying the LAN policy 116C, the routine 200 terminates, and the call session continues according to the LAN policy 116C. Alternatively, the routine 200 may return to operation 206, where the network classification module 112 continues to measure the RTT between the VoIP endpoint 104 and the mediation server 106. If the network classification module 112 determines that the measured RTT is not consistent with the LAN value 114C, then the routine 200 terminates, and the call session continues according to the default policy 116D applied at operation 204. Alternatively, the routine 200 may return to operation 206, where the network classification module 112 continues to measure the RTT between the VoIP endpoint 104 and the mediation server 106. In this case, the process may elect to ignore any new network classification until the call is finished. This approach has the advantage of keeping the same codec selection for the remaining duration of the call and therefore providing a consistent audio/video/data quality throughout the call. Alternatively, the process may allow the network classification to be re-evaluated and possibly changed on a periodic basis. This can be a desirable option if the initial period of RTT measurements was deliberately chosen to be small.

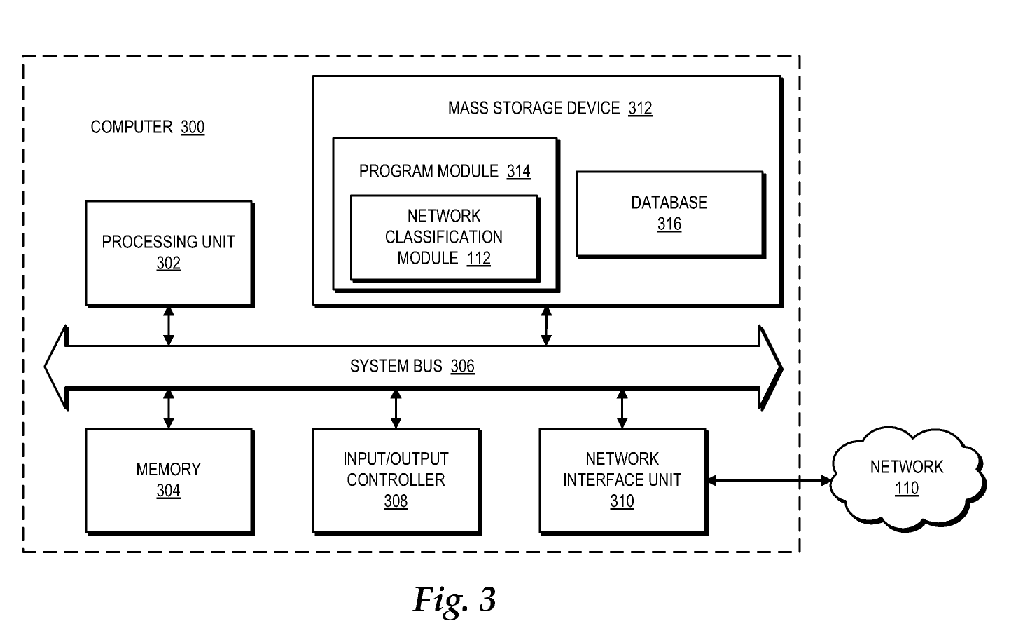

Referring now to FIG. 3, an exemplary computer architecture diagram showing a computer 300 is illustrated. Examples of the computer 300 may include the VoIP endpoint 104. The computer 300 includes a processing unit 302 (“CPU”), a system memory 304, and a system bus 306 that couples the memory 304 to the CPU 302. The computer 300 further includes a mass storage device 312 for storing one or more program modules 314 and one or more databases 316. An example of the program modules 314 may include the network classification module 112. The routine 200 may also be embodied in a program module and executed by the computer 300. The mass storage device 312 is connected to the CPU 302 through a mass storage controller (not shown) connected to the bus 306. The mass storage device 312 and its associated computer-readable media provide non-volatile storage for the computer 300. Although the description of computer-readable media contained herein refers to a mass storage device, such as a hard disk or CD-ROM drive, it should be appreciated by those skilled in the art that computer-readable media can be any available computer storage media that can be accessed by the computer 300.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 300.

According to various embodiments, the computer 300 may operate in a networked environment using logical connections to remote computers through a network, such as the computer network 110. The computer 300 may connect to the computer network 110 through a network interface unit 310 connected to the bus 306. It should be appreciated that the network interface unit 310 may also be utilized to connect to other types of networks and remote computer systems. The computer 300 may also include an input/output controller 308 for receiving and processing input from a number of input devices (not shown), including a keyboard, a mouse, a microphone, and a game controller. Similarly, the input/output controller 308 may provide output to a display or other type of output device (not shown).

Based on the foregoing, it should be appreciated that technologies for dynamically determining a network classification are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for dynamically determining a network classification, the method comprising performing computer-implemented operations for:
measuring a round trip time (RTT) between a Voice over Internet Protocol (VoIP) endpoint and a mediation server across a network;
determining whether the measured RTT is consistent with one of a plurality of network classification values, each of the plurality of network classification values corresponding to a network policy; and
in response to determining that the measured RTT is consistent with one of the plurality of network classification values, applying the corresponding network policy to configure bandwidth management on the VoIP endpoint.

2. The computer-implemented method of claim 1, further comprising prior to measuring the RTT between the VoIP endpoint and the mediation server across the network, applying a default network policy on the VoIP endpoint.

3. The computer-implemented method of claim 1, wherein the network classification values comprise a wide area network (WAN) value and a local area network (LAN) value.

4. The computer-implemented method of claim 3, wherein in response to determining that the measured RTT is consistent with one of the plurality of network classification values, applying the corresponding network policy comprises:
in response to determining that the measured RTT is consistent with the WAN value, applying a WAN policy; and
in response to determining that the measured RTT is consistent with the LAN value, applying the LAN policy.

5. The computer-implemented method of claim 1, wherein the network policy comprises a codec selection or a bitrate selection.

6. The computer-implemented method of claim 1, wherein measuring a RTT between a VoIP endpoint and a mediation server comprises measuring the RTT between the VoIP endpoint and the mediation server until a statistical trend is achieved.

7. The computer-implemented method of claim 6, wherein the statistical trend comprises a standard deviation below a threshold.

8. The computer-implemented method of claim 1, wherein determining whether the measured RTT is consistent with one of a plurality of network classification values comprises determining whether the measured RTT is within a threshold of the network classification values.

9. The computer-implemented method of claim 1, wherein measuring a RTT between a VoIP endpoint and a mediation server across a network comprises measuring an amount of time for a packet to be sent from the VoIP endpoint to the mediation server and for an acknowledgement to be returned from the mediation server to the VoIP endpoint.

10. A computer system comprising:
a processor;
a memory operatively coupled to the processor; and
a program module (i) which executes in the processor from the memory and (ii) which, when executed by the processor, causes the computer system to dynamically determine network classification by:
applying a default network policy on a Voice over Internet Protocol (VoIP) endpoint, the default network policy setting a bandwidth management on the VoIP endpoint;
upon applying the default network policy on the VoIP endpoint, measuring a round trip time (RTT) between the VoIP endpoint and a mediation server across a network;
determining whether the measured RTT is consistent with one of a plurality of network classification values, each of the plurality of network classification values corresponding to a network policy; and
in response to determining that the measured RTT is consistent with one of the plurality of network classification values, applying the corresponding network policy to transform the bandwidth management on the VoIP endpoint.

11. The computer system of claim 10, wherein the network classification values comprise a wide area network (WAN) value, a metropolitan area network (MAN), and a local area network (LAN) value.

12. The computer system of claim 11, wherein in response to determining that the measured RTT is consistent with one of the plurality of network classification values, applying the corresponding network policy comprises:
in response to determining that the measured RTT is consistent with the WAN value, applying a WAN policy;
in response to determining that the measured RTT is consistent with the MAN value, applying a MAN policy; and
in response to determining that the measured RTT is consistent with the LAN value, applying the LAN policy.

13. The computer system of claim 10, wherein the network policy comprises a codec selection or a bitrate selection.

14. The computer system of claim 10, wherein measuring a RTT between a VoIP endpoint and a mediation server comprises measuring the RTT between the VoIP endpoint and the mediation server until a statistical trend is achieved.

15. The computer system of claim 14, wherein the statistical trend comprises a standard deviation below a threshold.

16. The computer system of claim 10, wherein determining whether the measured RTT is consistent with one of a plurality of network classification values comprises determining whether the measured RTT is within a threshold of the network classification values.

17. A computer-readable medium having computer-executable instructions stored thereon which, when executed by a computer, cause the computer to:
establish a call session between a Voice over Internet Protocol (VoIP) endpoint and a public switched telephone network (PSTN) telephone via a mediation server, the mediation server operative to enable the call session between the VoIP endpoint and the PSTN telephone;
apply a default network policy on the VoIP endpoint for the call session, the default network policy setting a bandwidth management on the VoIP endpoint;
upon applying the default network policy on the VoIP endpoint, measure a round trip time (RTT) between the VoIP endpoint and the mediation server across a network;
determine whether the measured RTT is consistent with a WAN network classification value or a LAN network classification value, the WAN network classification value corresponding to a WAN network policy, the LAN network classification value corresponding to a LAN network policy;
in response to determining that the measured RTT is consistent with the WAN network classification value, apply the WAN network policy to configure the bandwidth management on the VoIP endpoint; and
in response to determining that the measured RTT is consistent with the LAN network classification value, apply the LAN network policy to configure the bandwidth management on the VoIP endpoint.

18. The computer-readable medium of claim 17 having further computer-executable instructions stored thereon which, when executed by a computer, cause the computer to in response to:
determine whether the measured RTT is consistent with a MAN network classification value corresponding to a MAN network policy; and
in response to determining that the measured RTT is consistent with the MAN network classification value, apply the MAN network policy to configure the bandwidth management on the VoIP endpoint.

19. The computer-readable medium of claim 17, wherein the LAN network policy comprises a first codec selection, the first codec selection operating at a first bitrate, and the WAN network policy comprises a second codec selection, the second codec selection operating at a second bitrate.

20. The computer-readable medium of claim 17, wherein to measure a RTT between a VoIP endpoint and the mediation server, the computer-readable medium having further computer-executable instructions stored thereon which, when executed by a computer, cause the computer to measure the RTT between the VoIP endpoint and the mediation server until a statistical trend is achieved.
